(19) United States
(12) Patent Application Publication
(10) Pub. No.: US 2017/0274268 A1
(43) Pub. Date: Sep. 28, 2017

(54) INTERACTIVE EXERCISE DEVICES AND SYSTEMS

(71) Applicant: University of Central Florida Research Foundation, Inc., Orlando, FL (US)

(72) Inventor: Chaithanya Renduchintala, Orlando, FL (US)

(21) Appl. No.: 15/465,353

(22) Filed: Mar. 21, 2017

Related U.S. Application Data
(60) Provisional application No. 62/311,641, filed on Mar. 22, 2016.

(51) Int. Cl. A63B 71/06; A63F 13/285; A63F 13/211; A63B 24/00; A63F 13/816

(52) U.S. Cl. CPC A63B 71/0622; A63B 24/0003; A63B 24/0087; A63F 13/816; A63F 13/211; A63F 13/285; A63B 2071/0625; A63B 2225/20; A63B 2225/50; A63B 2071/0638; A63F 2300/8005; A63F 2300/105; A63F 2300/302

(57) ABSTRACT

In accordance with at least one aspect of this disclosure, an exercise device can include a body configured to be gripped by a user, wherein the body is configured to be used for exercise, at least one sensor attached to the body and configured to sense a motion, position, and/or orientation of the body, and at least one controller configured to receive sensor signals from the sensor and to send sensor signals or data to a remote computer. The body can be an exercise bar or any other suitable shape.

### CROSS-REFERENCE TO RELATED APPLICATIONS

This application claims priority to and the benefit of U.S. Provisional Application No. 62/311,641, filed Mar. 22, 2016, the entire contents of which are herein incorporated by reference in their entirety.

### BACKGROUND

### 1. Field

The present disclosure relates to exercise and therapy, more specifically to exercise devices and systems (e.g., for cerebral palsy therapy).

### 2. Description of Related Art

Currently available exercise devices, e.g., for cerebral palsy (CP) therapy is a wooden baton that the kids lift over their head. An instructor visually observes and assists them. The average lifetime expenses a family may expect can go up to about $1 MM for each child with CP. Children with associated disabilities will cost more; an average of a little over $1 MM is needed for children with intellectual disabilities, over $600,000 for vision impairment, and over $380,000 for hearing loss, for example.

Conductive Education strengthens the child's muscles, and allows their central nervous system to form new neurological connections, despite neurological damage. These new connections allow children in such a program to move more independently. Conductive Education teaches children with motor disabilities how to control their arms, legs, head, and trunk. With this control, they are able to grab and hold items, lift their bodies, stand, and even walk, eliminating their need for constant assistance.

Such conventional methods and systems have generally been considered satisfactory for their intended purpose. However, there is still a need in the art for improved exercise devices and systems. The present disclosure provides a solution for this need.

### SUMMARY

In accordance with at least one aspect of this disclosure, an exercise device can include a body configured to be gripped by a user, wherein the body is configured to be used for exercise, at least one sensor attached to the body and configured to sense a motion, position, and/or orientation of the body, and at least one controller configured to receive sensor signals from the sensor and to send sensor signals or data to a remote computer. The body can be an exercise bar or any other suitable shape.

The body can include a grip proximal each end of the exercise bar. Each grip can include a vibrating grip configured to be powered (e.g., via an electric motor) to vibrate the grip. The body can include one or more lights disposed thereon (e.g., a plurality of lights of different colors and/or in different positions). In certain embodiments, the body can include at least one speaker.

The controller can include a wireless communication device configured to communicate with a remote computer wirelessly to send the sensor signals or the data thereto. The controller can be configured to control at least one of the vibrating grips, the one or more lights, or the at least one speaker. The controller can be configured to receive response signals from the remote computer to control at least one of the vibrating grips, the one or more lights, or the speaker (e.g., for sensible feedback from the remote computer as part of an interactive computer program, e.g., an interactive computer game).

In accordance with at least one aspect of this disclosure, a non-transitory computer readable medium includes computer executable instructions for executing a method, the method comprising, receiving a sensor signal or data from an exercise device using the signal or data from the exercise device as a control input for an interactive computer program, and sending an output signal to a display to display the interactive computer program for a user to view the interactive computer program. The interactive computer program can include a video game, for example.

The method can include storing the signal or data in a database. The method can further include performing analysis on the data in the database and providing the data and/or or analysis to a third party instructor for monitoring of a medical condition. For example, the medical condition can be cerebral palsy. The method can further include sending a response signal to the exercise device to control at least a portion of the exercise device.

In accordance with at least one aspect of this disclosure, a cerebral palsy therapy system can include any suitable embodiment of an exercise device as described herein and a computer configured to receive the sensor signals from the exercise device, the computer comprising any suitable embodiment of a non-transitory computer readable medium such that the computer can to execute any suitable method or portion thereof as described herein. The system can further include a display for displaying output of the interactive computer program, for example.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a system in accordance with this disclosure;

FIG. 2 is a schematic view of an embodiment of a database in accordance with this disclosure;

FIG. 3 is a functional view of an embodiment of a framework in accordance with this disclosure; and

FIGS. 4 and 5 are schematic views of an embodiment of a display in accordance with this disclosure, showing an interactive feedback view of an interactive program in accordance with this disclosure.

### DETAILED DESCRIPTION

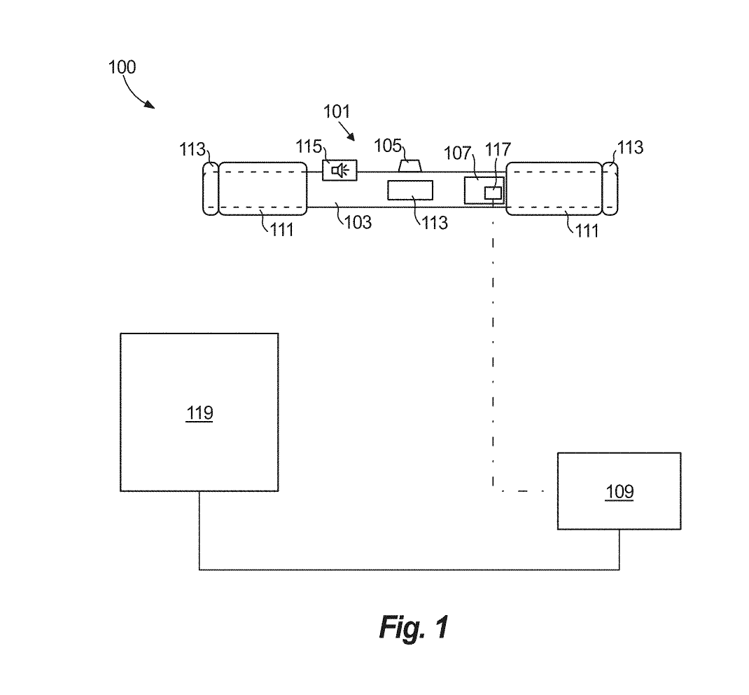

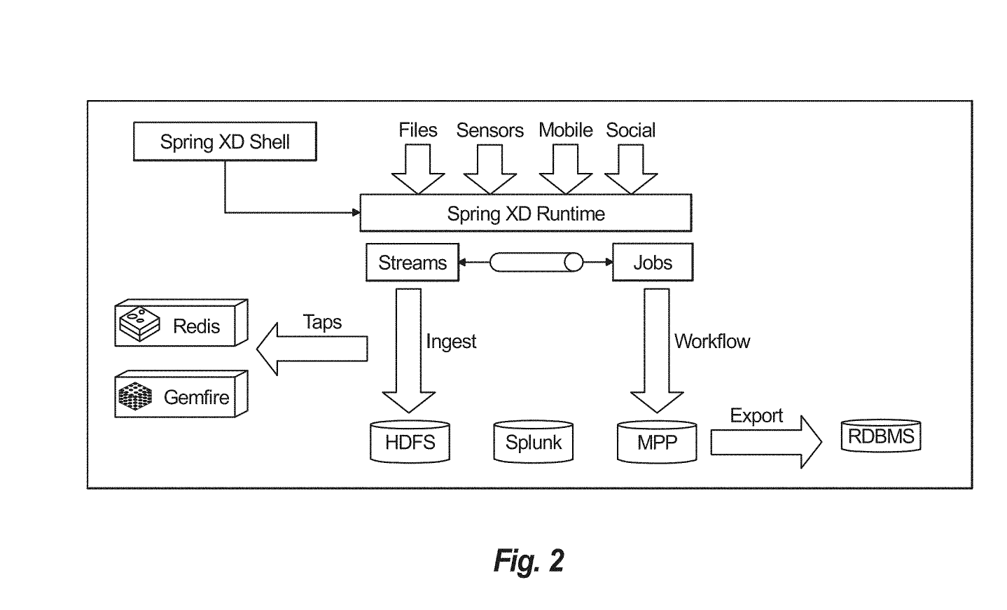

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-4. The systems and methods described herein can be used to improve user health and as therapy for certain diseases, for example. Any other suitable use is contemplated herein.

In accordance with at least one aspect of this disclosure, a system 100 can include an exercise device 101. The exercise device 101 can include a body 103 configured to be gripped by a user (e.g., a cerebral palsy patient). The body 103 can be configured to be used for exercise (e.g., baton shaped such that it has a graspable surface and properly located center of gravity, e.g., at the center of the body 103). The body 103 can be an exercise bar or any other suitable shape for use in exercising.

At least one sensor 105 attached to (e.g., on or within) the body 103 and configured to sense a motion, position, and/or orientation of the body 103. At least one controller 107 can be disposed on or within the body 103 and can be configured to receive sensor signals from the at least one sensor 105 and to send sensor signals or data to a remote computer 109. In certain embodiments, the at least one sensor 105 can include one or more of an accelerometer, a gyroscopic device (e.g., for orientation measurement), or a position device (e.g., a GPS). In certain embodiments, the device 101 can include an accelerometer, a gyroscope, and a pressure sensor (e.g., for sensing grip strength of a user). The at least one sensor 105 can include any suitable sensor or sensors as appreciated by those having ordinary skill in the art (e.g., a heart monitor, a temperature sensor, a visual sensor for recording images of a user).

The body 103 can include a grip 111 proximal each end of the exercise bar. Each grip 111 can include a vibrating grip configured to be powered (e.g., via an electric motor) to vibrate the grip 111 (e.g., for tactile feedback). Any suitable grip 111 is contemplated herein.

The body 103 can include one or more visual display (e.g., lights 113) disposed thereon (e.g., a plurality of lights of different colors (red, yellow) and/or in different positions). For example, the body 103 can include a yellow light at each end and a red light in the center of the body 103. Any suitable visual display (e.g., an LED screen) is contemplated herein.

In certain embodiments, the body 103 can include at least one speaker 115 disposed on or within the body 103. Any suitable size or type of audible device is contemplated herein, e.g., to provide audible feedback to the user. In certain embodiments, there can be combination of buzzers, speakers, and lights, or some of these may not be included. However the sensor 105 and at least one feedback device (e.g., such as a buzzer, speaker, vibrating grips, or lights or computer based display of game) and/or a data collection system that tracks user performance for analysis can be included.

The controller 107 can include a wireless communication device 117 configured to communicate with a remote computer 109 wirelessly to send the sensor signals or the data thereto. Any suitable type of wireless communication device 117 is contemplated herein (e.g., wifi, Bluetooth). The controller 107 can be operatively connected to and configured to control at least one of the vibrating grips 111, the one or more lights 113, or the at least one speaker 115 (e.g., as a function of a controllable stated such as on/off, and/or as a function of a received response signal for feedback from the remote computer 109).

For example, the controller 107 can be configured to receive response signals from the remote computer 109 to control at least one of the vibrating grips 111, the one or more lights 113, or the at least one speaker 115 (e.g., for sensible feedback from the remote computer 109 as part of an interactive computer program, e.g., an interactive computer game). The controller 107 can include any suitable hardware (e.g., a microprocessor, circuits, etc.) and/or any suitable software (e.g., any suitable computer code).

In accordance with at least one aspect of this disclosure, the system 100 can be used as a cerebral palsy therapy system and can include any suitable embodiment of an exercise device 101 any suitable embodiment of a computer 109 configured to receive the sensor signals from the exercise device 101. The computer 109 can include any suitable embodiment of a non-transitory computer readable medium such that the computer can to execute any suitable method or portion thereof as described herein. The system 100 can further include a display 119 for displaying output of the computer 109 (e.g., an interactive computer program), for example.

In accordance with at least one aspect of this disclosure, a non-transitory computer readable medium includes computer executable instructions for executing a method, the method comprising, receiving a sensor signal or data from an exercise device using the signal or data from the exercise device as a control input for an interactive computer program, and sending an output signal to a display to display the interactive computer program for a user to view the interactive computer program. The interactive computer program can include a video game, for example.

Embodiments of a computer program can incorporate inputs from a plurality of devices such as the exercise bar or other devices that can be operated by the user/patient and by other users/patients such that the users can interact with each other via the game for example a multiplayer game or a competition game played by two or more users simultaneously from remote locations.

The method can include storing the signal or data in a database. The method can further include performing analysis on the data in the database and providing the data and/or or analysis to a third party instructor for monitoring of a medical condition. For example, the medical condition can be cerebral palsy. The method can further include sending a response signal to the exercise device to control at least a portion of the exercise device.

Embodiments implement the concept of incorporating internet of things (IoT) on an embodiment of an exercise bar 101 used by the people (e.g., children) having cerebral palsy. Cerebral palsy is a group of permanent movement disorders that appear in early childhood.

Often, symptoms include poor coordination, stiff muscles, weak muscles, and tremors. Babies with cerebral palsy do not roll over, sit, crawl, or walk as early as other children their age. Previous exercise sticks were used by patients to perform exercises to improve motor control. The instructors access these and give them feedback to perform better and in turn gain better control. Embodiments of this disclosure are intelligent by fitting sensors thereon and collecting data from the exercise bar. Based on the data collected, the instructors can give more accurate feedback. Also an interactive game or program can created which patients can get visual feedback from.

Certain embodiments pertain to the exercise bar 101 and related systems, a data aggregation and analysis platform, and game/visual feedback/sensory feedback.

As described above, the exercise bar can be a stick, rod, pipe, wheel, or any other suitable body that a user currently uses to hold and do exercises. Doing exercises can help in hand-eye coordination, improve motor control, and also provide exercise to weak muscles.

At the present moment, the instructor is present with a user (e.g., a child with CP) during the exercise routine and gives feedback and corrects the posture if needed. The instructor also gives their opinion about the improvement of the child based on their experience with interacting with the child. But this happens only at the facility and when the user gets home, he/she cannot be monitored because the parent might not know the routine nor the correct posture. So it becomes difficult for the user to do the same exercises at home.

Embodiments include one or more sensors 105 that are incorporated with the exercise device 101 which can track the movement of the device 100 in real-time so as to collect data. This data can be stored on a database and can be analyzed over a period time, for example. This can act as or replace the instructor's feedback system and improvement of the users exercise can be evaluated.

Embodiments include a controller 107 (e.g., a microcontroller) with one or more sensors 1105 attached to it. This wirelessly sends out the data back to the computer/database/cloud for further processing and analyzing. The basic sensor that is attached can include an accelerometer, gyroscope, pressure sensor and some visual indication lights. These sensors can collect the movement as and when the device 101 is moved sending all these data as a cluster in a data format wirelessly (e.g., through the controller 107). When the data reaches the target, e.g., a database, further processing can be performed on the data. The accelerometer can collect the movement in the x, y, and z axes. The gyroscope can collect the roll, pitch and yaw of the device 101. The pressure sensor can determine the grip strength of the user during the exercises which can also important to monitor the user's progress.

The data from these sensors can be collected by the controller 107 and sent wirelessly through Wi-Fi/Bluetooth/RF protocol, or any other suitable means (e.g., via a wire). The data from the sensors can be encapsulated into a format packet specific to the application/database which processes this. These packets can be constantly streamed from the sensor to the server such that every movement of the user during performing exercises can captured. Any suitable platform can be used to integrate sensors on the prototype exercise device as appreciated by those skilled in the art (e.g., MSP430, Arduino, Intel Edison and other developer kits).

Embodiments enable exercise performance data capture, which facilitates a method to track exercise progression utilizing data from the sensors. The data can then provided via application program interfaces (APIs) that can be used to develop a game/motivational interface to enhance the experience of the user. Embodiments of the exercise bar 101 can be incorporated with feedback elements such as led lights, speakers and vibrating pads that alert the user when tilt exceeds a certain predetermined level (e.g., lights blink with increasing frequency according to tilt). Titling the bar or the inability to keep the bar aligned to the horizontal place during the performance of the exercise is usually the result of unilateral deficits that characterize patients with CP.

Thus the system 100 can be used as an exercise and therapy platform and can facilitate a method of data capture and utilization to enhance user experience. Users can be children with CP and other conditions that result in unilateral motor deficits. A further use of certain embodiments includes supporting Conduction Therapy. These centers rely on wooden sticks and human observation to track progression. The system described in this innovation compliments human observation with real time feedback, further it supplements encouragement provided by the trainer with audio, visual and tactile feedback form the device itself. Additionally the game based interface allows the setting of long term exercise goals and tracking of accomplishments that can be analyzed to complement human observation while formulating child specific plans and targets.

Referring to FIG. 2, the database can be stored in any suitable location (e.g., on remote computer 109) and receives the data from the sensor via the controller 107. The data packets can then then stripped into the components and then put into a database. In the embodiment of FIG. 2, a framework like Spring XD is used which encompasses all the modules and does all the necessary things to modify the data. The data base framework can take care of storing all the previous data and performing all analytics on it as well.

Using Spring XD or similar platform can be beneficial because it is a unified platform, it is open and extensible, it is developer friendly, it has analytics integrated, it is monitoring and management supported, and it has distributed runtime. The above are some of the reasons for choosing a framework like Spring XD for certain embodiments. Embodiments can cause a lot of real-time data to be streamed from the one or more sensors, so embodiments of the framework should be able to handle this data and process it effectively. Not only storage is a function of such a framework, but here data is sent to various modules inside the framework since it is a modulated framework. Examples of other IOT platforms that can be used to support the system include AWS IOT platform, Google Cloud Platform, or other cloud based services.

The stream of data can be first saved in a big data table which can be mostly a relational NoSQL database like the open source Apache Hadoop or a relational database management system (RDMBS). This can also be a scalable environment. Key components of data processing in Spring XD include Stream, Jobs, and Taps.

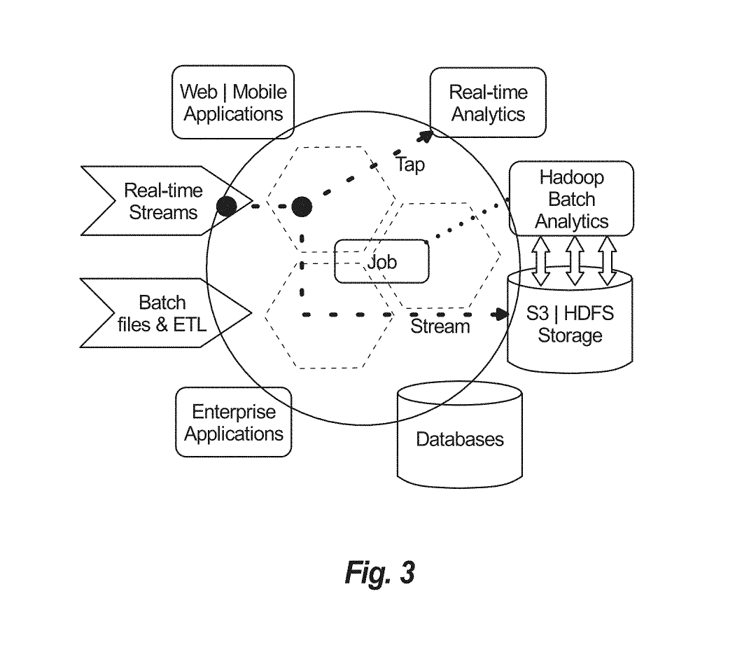

Referring additionally to FIG. 3, Streams define how event driven data is collected, processed, and stored or forwarded. Jobs define how coarse grained and time consuming batch processing steps are orchestrated. Taps are used to process data in a non-invasive way as data is being processed by a Stream or a Job. Much like wiretaps used on telephones, a Tap on a Stream lets you consume data at any point along the Stream's processing pipeline. The behavior of the original stream is unaffected by the presence of the Tap.

The database can also be used to learn about the progress of the exercise bar user. The progress can be calculated by the amount of improvement from the previous set of data to the current data. Once a data set and history are obtained, the results can be calculated on the fly. Many other areas of data analysis and data research can be unlocked in this regard. Prediction can also be had by incorporating machine learning and artificial intelligence. The data can then be formatted and made useful for an instructor to view it and make changes to the data. The instructor can view the data for any user at any particular time and based on that make suggestions and give their feedback.

Embodiments also allow unsupervised training of the exercises for a user at home. For example, a child CP patient can do the exercises and the parents can monitor the data. The application will can be configured to at least state if the child is doing the exercise in a correct fashion and store all the values, for example. This can later be processed and get approved at a later stage by the instructor.

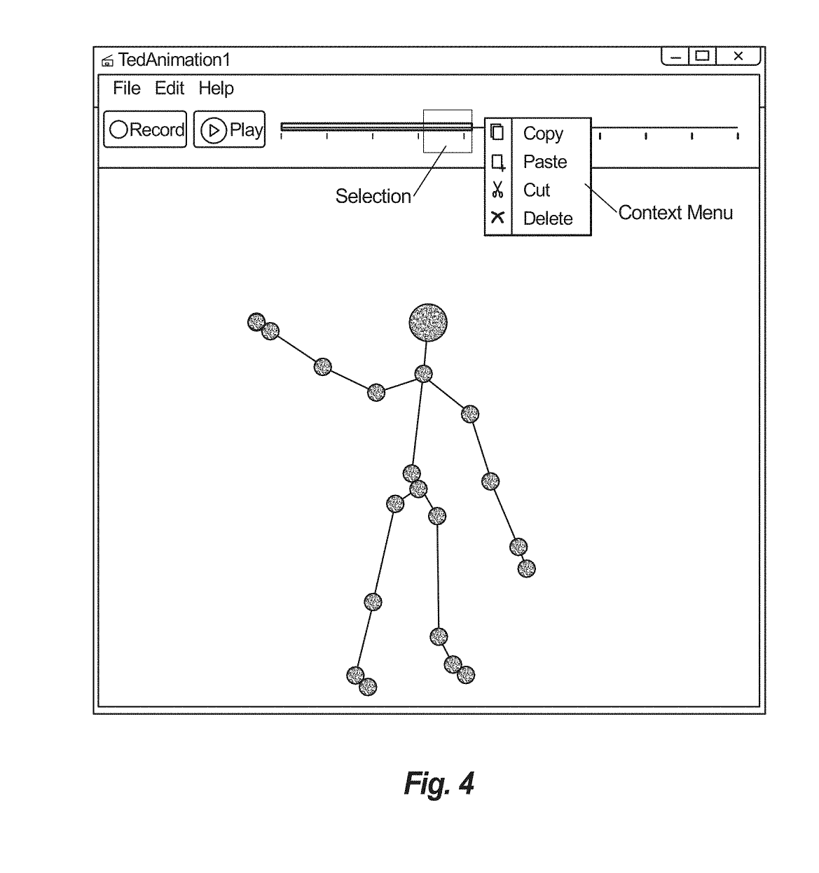

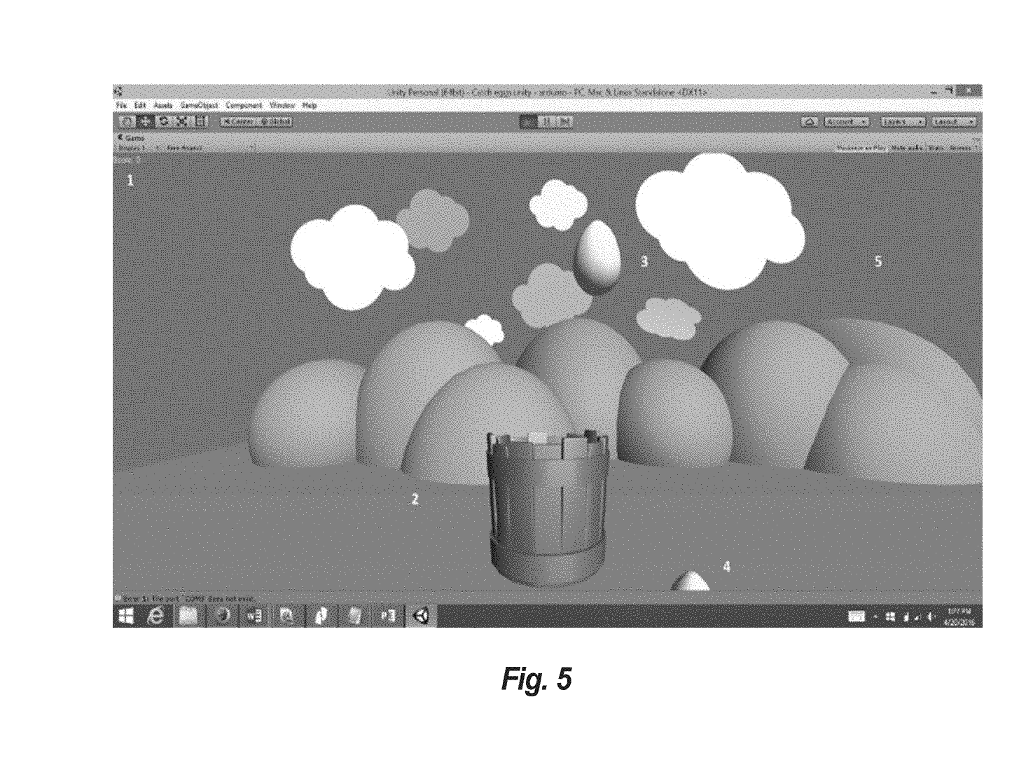

Referring additionally to FIGS. 4 and 5, the embodiments as described above can include a visual feedback for the user. The user at the present is doing the monotonous task every single day. There is no motivation or a visual feedback that the user gains from doing so. Motivation can be provided by the activity then the user can experience greater joys. Any child, for example, would enjoy to playing a game and get motivated by such interactive software. So the interactive exercise bar can provides joy and motivation for a user and in turn make the user do more and improve in progress.

Embodiments provide APIs that an application or the game designer can use to create a game that the user will see on the screen and interact with by movement of the bar. By this way the user can gain some motivation and will also be able to interact and perform better. The exercise bar is regularly streaming data to the database. So by use of the APIs, the application and game designer can capture the data, and use them in the relative motion on the screen thus incorporating real time game like animation (e.g., as shown in FIGS. 4 and 5) which is very engaging and interactive.

Embodiments allow measurement the mechanical performance of kids with CP and monitoring of their ability to play, e.g., simple 2D games when presented with input devices with form factors similar to devices they encounter while in CECO class environment or other everyday objects they use. Embodiments include motivational sensory paradigms using light and auditory cues that are generated by the use of the devices.

Embodiments include interactive exercise bars which can be used to perform exercises or any other suitable device (e.g., a flexible tensile stress measuring car steering cover, or something similar to measure grip strength). Other interactive-devices can be integrated that exhibit unique game-like behavior when brought in proximity of embodiments of devices to serve as physical motivational elements. Game development can be used to project both the exercise-device and the interactive-device onto a game space to provide added fantasy based motivation. Open sourced environments can be used that allow others to contribute and create games using data input from sensors. Any suitable data-analytics platforms can be used to analyze data patterns and develop personalized condition-models to help with the therapy and exercise planning, for example.

Currently available exercise devices include a wooden baton that the kids lift over their head and the instructor observes and assists them. Embodiments gather exercise performance data which can then be used in evaluation and/or an interactive program resulting in motivation. The data can be analyzed for patterns that can potentially have therapeutic benefit. Embodiments can result in a more fun exercise for a user (e.g., a child with CP) using sensor feedback.

Embodiments include a device to capture gyroscope and/or accelerometer data from a lightweight pipe shaped device that can be easily gripped and used to perform stick based exercises typically used in conductive education or other rehabilitative exercises. Embodiments enhance motivation to perform exercises. Embodiments generate data to track user performance. Embodiments increase stimulation of the user by allowing other users to use a similar device and interact via a web based game. Embodiments track progress toward individual exercise goal plans and alert to care giver on progress.

Embodiments include a customized PCB board that fits within the said pipe and provides connections for the gyroscope and/or accelerometers, wifi chips, e.g., as ESP 8266 and or the Wemos Mini D1 board. Embodiments include a mobile smart phone application that is used to capture perception feedback from caregivers. Embodiments include a mobile smart phone application to set the home/office router wifi password on the ESP8266, and/or configure the device settings, e.g., intensity of buzzing, etc. Embodiments of a mobile phone application can be configured to select the game for the user(s) to play using the device(s). The mobile application can include an exercise performance survey that can be filled out by the care provider.

Embodiments include deployment of cloud infrastructure to support multiplayer gaming, data capture and analysis. Data can be analyzed to determine the proximal, intermediate, and distal outcome measures and to classify or group users and predict improvement of performance over time, for example.

As will be appreciated by those skilled in the art, aspects of the present disclosure may be embodied as a system, method or computer program product. Accordingly, aspects of the this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Any suitable computing device can be utilized with the computer readable medium (e.g., a mobile device, a PC).

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the this disclosure are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Traditionally, therapy was done using wooden and plastic sticks. A child would be assisted by the instructor while doing the exercise. The instructor gets a sense of the child's progress over time (e.g., several months) and modifies the exercise plan. This progress is captured in a document and placed in the child's file. Repeated performance of the exercise and the corrective stimuli provided by the instructor and over time this results in improvement in motor function.

By embedding at least one sensor (e.g., gyroscope and accelerometer) and a wireless chip in the interactive exercise bar, we allow for capture of exercise data to track performance in real time. By using the sensor data to provide real time on device feedback via buzzers/speakers/vibration pads or off device feedback such as a web based game/multiplayer game we provide the child with stimuli to help the child improve motor skills. Embodiments increase stimuli and cause a greater level of independence. As part of the system, a mobile computer application (e.g., for a smart phone or tablet device) can be configured to communicate with the interactive exercise bar and to capture performance perception of the care giver/instructor, for example.

Multiplayer games further increase stimuli and group activity of the higher functioning children and in theory increased positive stimuli along with encouragement and engagement should help in recovery.

Embodiments include Child-Centered Interactive Exercise Devices CCIED and systems that can immerse a child in an interaction rich environment that motivates physical and enjoyable mental exercise independently or with peers via a multiplayer game. Embodiments can allow for peer to peer interaction, via an online browser based multiplayer game environment. Motivational and persuasive system design principles such as social recognition, praise and reward can be applied to create motivational experiences for each child based on their interests. The interface between the gaming environment and the child can comprise of networked physical devices that capture both effort and interaction. The form factors of these devices can resemble everyday exercise and play objects the child routinely encounters. Further, the system by means of these devices such as the interactive exercise bar, the intelligent exercise steering wheel, and the telepresence ball and proximity magic box can inform, initiate and encourage the child to join peers during the performance of the exercise. The exercises devices in the system can continually encourage the child to push at the boundaries of their current limitations. The dashboard can include an analytics platform that can capture the child's exercise and interaction patterns, which can enable identification and personalization of the system to meet the motivational needs of each child. This facilitates the tracking of progression which typically takes place gradually over years and planning of new activities and experiences for the child.

Embodiments can provide parents and instructors with an interactive dashboard to configure device settings such as resistance levels, prompts and interactive features such as intensity and frequency of audio-visual-tactile cues. Initial configuration of the system can take into consideration the cognitive and physical status of the child including their ability to perform very specific tasks such as walking, sitting, eating, lifting objects, wearing clothes and finer motor control activities. The dashboard can include an analytics platform that can capture the child's exercise and interaction patterns, this can enable identification and personalization of the system to meet the motivational needs of each child. This facilitates the tracking of progression which typically takes place gradually over years and planning of new activities and experiences for the child. This can facilitate remote care at in home settings improving accessibility of high quality care at much reduced costs.

The methods and systems of the present disclosure, as described above and shown in the drawings, provide for exercise devices with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. An exercise device, comprising:
a body configured to be gripped by a user, wherein the body is configured to be used for exercise;
at least one sensor attached to the body and configured to sense a motion, position, and/or orientation of the body; and
at least one controller configured to receive sensor signals from the sensor and to send sensor signals or data to a remote computer.

2. The device of claim 1, wherein the body is an exercise bar.

3. The device of claim 2, wherein the body includes a grip proximal each end of the exercise bar.

4. The device of claim 3, wherein each grip includes a vibrating grip configured to be powered to vibrate the grip.

5. The device of claim 4, wherein the body includes one or more lights disposed thereon.

6. The device of claim 5, wherein the body includes at least one speaker.

7. The device of claim 6, wherein the controller includes a wireless communication device configured to communicate with a remote computer wirelessly to send the sensor signals or the data thereto.

8. The device of claim 7, wherein the controller is configured to control at least one of the vibrating grips, the one or more lights, or the at least one speaker.

9. The device of claim 8, wherein the controller is configured to receive response signals from the remote computer to control at least one of the vibrating grips, the one or more lights, or the speaker.

10. A non-transitory computer readable medium, comprising computer executable instructions for executing a method, the method comprising:
receiving a sensor signal or data from an exercise device;
using the signal or data from the exercise device as a control input for an interactive computer program; and
sending an output signal to a display to display the interactive computer program for a user to view the interactive computer program.

11. The non-transitory computer readable medium of claim 10, wherein the interactive computer program includes a video game.

12. The non-transitory computer readable medium of claim 10, wherein the method includes storing the signal or data in a database.

13. The non-transitory computer readable medium of claim 12, further comprising performing analysis on the data in the database and providing the data and/or or analysis to a third party instructor for monitoring of a medical condition.

14. The non-transitory computer readable medium of claim 10, wherein the medical condition is cerebral palsy.

15. The non-transitory computer readable medium of claim 10, further comprising sending a response signal to the exercise device to control at least a portion of the exercise device.

16. A cerebral palsy therapy system, comprising:
an exercise device, including:
a body configured to be gripped by a user, wherein the body is configured to be used for exercise;
at least one sensor attached to the body and configured to sense a motion, position, and/or orientation of the body; and
at least one controller configured to receive sensor signals from the sensor and to send sensor signals or data to a remote computer; and
a computer configured to receive the sensor signals from the exercise device, the computer comprising a non-transitory computer readable medium, comprising computer executable instructions for executing a method, the method comprising:
receiving a sensor signal or data from the exercise device;
using the signal or data from the exercise device as a control input for an interactive computer program; and
sending an output signal to a display to display the interactive computer program for a user to view the interactive computer program.

17. The system of claim 16, wherein further comprising a display for displaying output of the interactive computer program.

18. The system of claim 16, wherein the body is an exercise bar.

19. The system of claim 18, wherein the body includes a grip proximal each end of the exercise bar.

20. The system of claim 19, wherein each grip includes a vibrating grip configured to be powered to vibrate the grip.
